(19) United States
(12) Patent Application Publication
(10) Pub. No.: US 2015/0142320 A1
(43) Pub. Date: May 21, 2015

(54) MEASUREMENT TRANSFORMATION APPARATUS, METHODS, AND SYSTEMS

(71) Applicants: Dagang Wu, Katy, TX (US); Luis Emilio San Martin, Houston, TX (US); Batakrishna Mandal, Missouri City, TX (US)

(72) Inventors: Dagang Wu, Katy, TX (US); Luis Emilio San Martin, Houston, TX (US); Batakrishna Mandal, Missouri City, TX (US)

(73) Assignee: Halliburton Energy Services, Inc., Houston, TX (US)

(21) Appl. No.: 14/408,774

(22) PCT Filed: Aug. 28, 2012
(86) PCT No.: PCT/US12/52689

§ 371 Date: Dec. 17, 2014

(51) Int. Cl. G01V 3/38; G01V 13/00; G01V 3/30

(52) U.S. Cl. CPC G01V 3/38; G01V 3/30; G01V 13/00
USPC 702/11

(57) ABSTRACT

In some embodiments, an apparatus and a system, as well as a method and an article, may operate to receive electromagnetic measurement data characterizing a formation from at least one transmitter-receiver pair. Further activity includes transforming the electromagnetic measurement data into transformed measurement data by computing a wavelet transform over the electromagnetic measurement data to provide wavelet coefficients, removing the wavelet coefficients below a selected threshold to provide remaining coefficients, and synthesizing the transformed measurement data by computing a reverse wavelet transform over a combination of the remaining coefficients. Additional apparatus, systems, and methods are described.

### BACKGROUND

Understanding the structure and properties of geological formations can reduce the cost of drilling wells for oil and gas exploration. Measurements made in a borehole (i.e., down hole measurements) are typically performed to attain this understanding, to identify the composition and distribution of material that surrounds the measurement device down hole. To obtain such measurements, a variety of sensors are used, including induction tools.

Induction tools, and other sensors used to determine Earth formation electrical parameters surrounding a well bore, are susceptible to electrical noise. When noisy data is acquired, the accuracy of inversion, one of the more common data processing procedures (e.g., used to find an accurate model to reproduce measurements made in the field), is affected.

To reduce or remove the noise and improve the accuracy of formation modeling, Fourier transform-based, low-pass filters have been used. In theory, Fourier techniques are most effective to filter the noises that are globally periodic and stationary due to the nature of the sinusoid basis function. While the sinusoid basis function has very good localization in the frequency domain, it has no localization in the space domain. In addition, Fourier techniques do not operate to reduce or eliminate short-time, wideband noise spikes. Finally, ripple artifacts arise (due to the presence of Gibb's phenomena) whenever Fourier filtering is employed.

### BRIEF DESCRIPTION OF THE DRAWINGS

FIG. 1 includes a set of flow diagrams for two examples of a measurement transformation process according to various embodiments of the invention.

FIG. 2 is a flow chart illustrating several methods according to various embodiments of the invention.

FIGS. 3A-3H are graphs illustrating signal conditions at various stages in the measurement transformation processes and methods of FIGS. 1-2, according to various embodiments of the invention.

FIG. 4 illustrates a wireline system embodiment of the invention.

FIG. 5 illustrates a drilling rig system embodiment of the invention.

FIG. 6 is a flow chart illustrating several additional methods according to various embodiments of the invention.

FIG. 7 is a block diagram of an article according to various embodiments of the invention.

### DETAILED DESCRIPTION

To address some of the challenges described above, as well as others, apparatus, systems, and methods are described herein that apply wavelet processing to transform data acquired from down hole tools, such as multi-component induction (MCI) tools. The mechanism described herein is adaptive, so as to be applicable to different components, at different frequencies, with different physical spacing between the sensing elements. As a result, multi-stage wavelet processing can be applied to sub-domain, down hole measurement data to improve formation boundary classification, and to provide more accurate inversion results.

As will be explained in more detail below, a filtering method (sometimes denoted as “de-noising” herein) based on wavelet transformation can be applied to reduce noise in measurement data provided by down hole logging operations. The wavelet transform provides a range of resolution in both time and frequency by using windows of different lengths. The kernel of this transform permits filtering in two dimensions (i.e., phase (or location) and scale), instead of only one dimension, as occurs in more conventional, low-pass filtering methods. The inventive technique thus lends itself to local application, so that portions of the data having less noise can remain relatively undisturbed. Various example embodiments that can provide some or all of these advantages will now be described in detail.

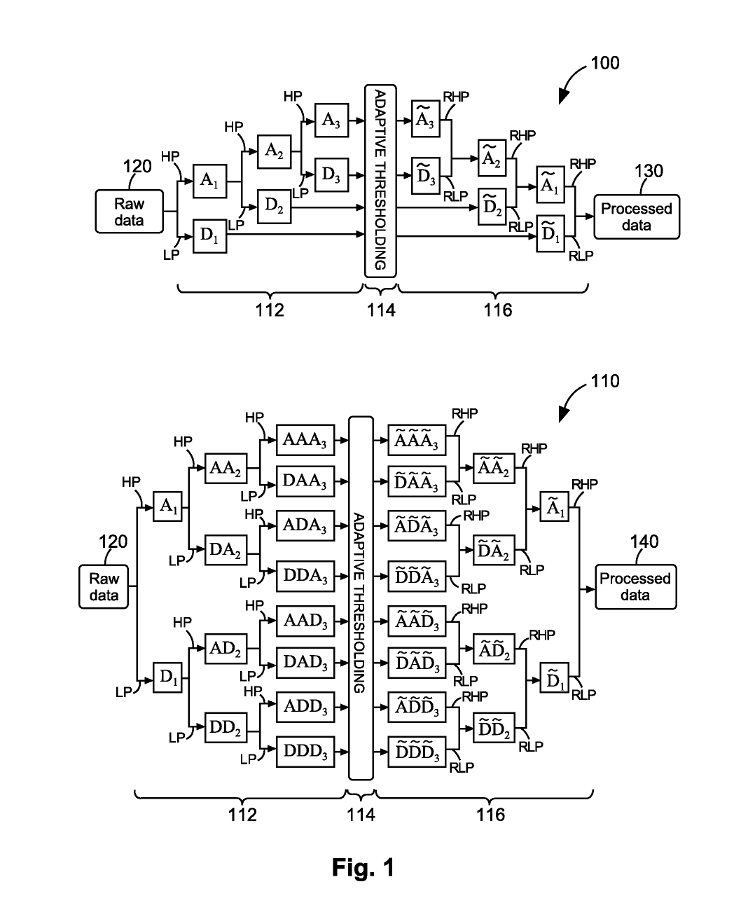

FIG. 1 includes a set of flow diagrams for two examples of a measurement transformation process 100, 110 according to various embodiments of the invention. In each example, it can be seen that signal de-noising using a multi-level wavelet transform comprises three successive stages: signal decomposition 112, thresholding 114 of the wavelet transform coefficients, and signal reconstruction 116.

The first process 100 provides an overview of a three-level wavelet transform, with the decomposition of approximation coefficients A₁, A₂, A₃. The second process 110 provides an overview of a three-level wavelet transform, with the decomposition of both approximation coefficients A₁, A₂, A₃, and detail coefficients D₁, DA₂, DD₂. In each case, greater or fewer levels of decomposition and reconstruction may be employed, as desired.

To begin the process 100, the wavelet transform is computed by passing the acquired, noisy signal successively through a high-pass filter HP and a low-pass filter LP to accomplish signal decomposition 112. For each decomposition level (e.g., in this case, three levels, or N=3), the high-pass filter HP provided by the wavelet function produces the approximation coefficients A_{N} The complementary low-pass filter LP provided by an associated scaling function produces the detail coefficients D_{N}. The end result is that the acquired, noisy signal 120 has been decomposed into the approximation coefficients A₃, and detail coefficients D₁, D₂, D₃, which are passed on to the next part of the process 100.

As part of the thresholding 114, wavelet coefficients corresponding to undesired frequency components are removed from the available approximation and detail coefficients. This provides a set of altered approximation and detail coefficients: Â₃, \hat{D}₁, \hat{D}₂, \hat{D}₃.

During reconstruction 116, the set of altered approximation and detail coefficients Â₃, \hat{D}₁, \hat{D}₂, \hat{D}₃ are synthesized into transformed (de-noised) data 130 over N levels, in a reverse time-sequence.

In some embodiments, an adaptive denoising method using a wavelet-packet transform can be applied in place of the wavelet processing described in the preceding paragraphs. In the wavelet-packet transform, both the approximation and detail coefficients are decomposed, as shown in process 110. Therefore, unlike what occurs with the wavelet transform-based de-noising process 100, the wavelet-packet de-noising process 110 not only removes noise at high frequencies, but also reduces undesired low-frequency signals in the log data.

Thus, the process 110 is somewhat similar to process 100, adding detail coefficient decomposition at each level. In this case, additional coefficients ADA₃, DDA₃, AD₂, DD₂, AAD₃, DAD₃, ADD₃, DDD₃ result. As a consequence, a larger set of coefficients (e.g., AAA₃, DAA₃, ADA₃, DDA₃, AAD₃, DAD₃, ADD₃, DDD₃) is available for presentation to the thresholding 114 operation. In turn, a greater number of altered coefficients (e.g., ÂÂÂ₃, \hat{D}ÂÂ₃, Â\hat{D}Â₃, \hat{D}\hat{D}Â₃, ÂÂ\hat{D}₃, \hat{D}Â\hat{D}₃, Â\hat{D}\hat{D}₃, \hat{D}\hat{D}\hat{D}₃) are provided for use during reconstruction 116, to synthesize the transformed signal 140.

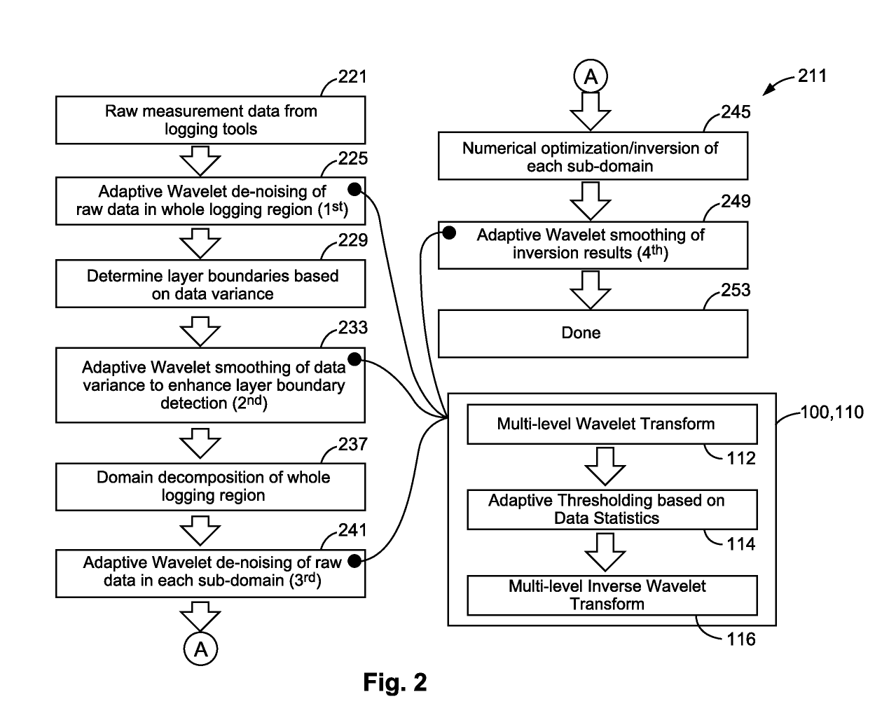

FIG. 2 is a flow chart illustrating several methods 211 according to various embodiments of the invention. Here it can be seen that the processes 100, 110 of FIG. 1 can be used multiple times, as part of a larger series of activities.

At block 221, raw measurement data (i.e., noisy data) is acquired from logging tools operating down hole. Such tools include MCI tools, among others.

At block 225, the processes 100, 110 may be applied, with more or less levels of decomposition/reconstruction, to transform the acquired data into transformed data, perhaps over an entire logging region.

At block 229, the layer boundaries can now more easily be determined, due to the reduction in noise provided as part of the activity at block 225. Sharp changes in the data may indicate the presence of a geological layer, as is well-known by those of ordinary skill in the art.

At block 233, the regions of data variance that have been discovered during the activity of block 229 can also be submitted to the processes 100, 110. The application of the processes 100, 110 at this stage operates to enhance the edges of the layers, providing a more accurate result.

At block 237, the entire raw data log is supplied as input, and the output comprises segmented log data. As a result of the processing in block 237, the entire raw data log is divided into several smaller segments, called sub-domains.

At block 241, the logging data from each sub-domain, resulting from the segmentation activity in block 237, can also be submitted to the processes 100, 110. The application of the processes 100, 110 at this stage operates to reduce the noise in the data for each sub-domain.

At block 245, the de-noised (filtered), transformed data for each sub-domain is inverted to provide an estimate of formation properties in each sub-domain, perhaps including formation resistivities and dip angle.

At block 249, the model data that has resulted from the activity of block 245 can also be submitted to the processes 100, 110. The application of the processes 100, 110 at this stage operates to smooth the inversion results obtained at block 245.

At block 253, the method 211 is complete. As a result, the original raw data that was acquired at block 221 has led to the provision of an accurate inversion model of the formation, which permits the determination of formation properties with a greater level of confidence over the entire logging region. Referring now to FIGS. 1 and 2, various details of the decomposition 112, thresholding 114, and reconstruction 116 activities will now be described.

### Decomposition 112 Activity

To begin, the wavelet decomposition of a noisy signal up to a chosen level N is conducted. In practice, the wavelet transform is computed by passing a signal successively through high-pass and low-pass filters HP, LP. For each decomposition level 1 . . . N, the high-pass filter HP provided by the wavelet function produces the approximation coefficients A₁, A₂, . . . , A_{N}. The complementary low-pass filter LP provided by an orthogonal scaling function produces the detail coefficients D₁, D₂, . . . , D_{N}. Equations (1)-(5) detail the decomposition functions used in the decomposition 112 activity:

$$\begin{matrix}{A}_{k}^{0} = {\sum }_{n} x ( n ) \cdot φ ( n - k ) & ( 1 ) \\ {D}_{k}^{j} = {\sum }_{n} {h}_{1 ( n - 2 k )} {A}_{n}^{j - 1} & ( 2 ) \\ {A}_{k}^{j} = {\sum }_{n} {h}_{0 ( n - 2 k )} {A}_{n}^{j - 1} & ( 3 ) \\ {h}_{0 k} = \frac{1}{\sqrt{2}} \int φ ( \frac{t}{2} ) \overline{φ} ( t - k ) d t , & ( 4 ) \\ {h}_{1 k} = \frac{1}{\sqrt{2}} \int ψ ( \frac{t}{2} ) \overline{φ} ( t - k ) d t , & ( 5 )\end{matrix}$$

Here, x represents the raw data with a sequence n, ψ is the wavelet function, is the scaling function orthogonal to ψ, φ̅ is the conjugate complex of φ, k is a phase variable, and superscript j represents the decomposition layer.

As is known by those of ordinary skill in the art, there are different types of wavelet functions ψ, each having associated scaling functions φ. For example, wavelet and scaling functions to be used during the decomposition 112 activity can be taken from any one or more of the following familes: Haar, Daubechies, Symlets, Coiflets, BiorSplines, Reverse Biorsplines, Meyer, Gaussian, Mexican Hat, Morlet, Shannon, and Frequency B-Spline, among others. The wavelet and scaling functions taken from these families may be of any order, including orders two through sixteen.

### Thresholding 114 Activity

Wavelet coefficients that represent noise over the decomposition levels 1 to N are removed as part of the thresholding 114 activity. The coefficients to be removed are those having small absolute values, which are considered to encode mostly noise in the raw signal data 120. By thresholding (e.g., setting selected ones of the coefficient values to zero) the smaller wavelet coefficients corresponding to undesired frequency components (e.g., frequencies below the resolution of the logging instrument, which in the case of an induction instrument, is based on the distance between transmitter and receiver coils), a transformed signal 130, 140, with less noise, can be produced as a result of the reconstruction 116 activity. Adaptive thresholding can also be implemented, where distinct threshold values are applied at different levels of the decomposition.

In some embodiments, risk-based threshold selection is used. For instance, threshold selection criteria can be put in place based on minimizing Stein's Unbiased Risk Estimate (SURE) or the Bayesian Estimate of Risk (BER).

The selected threshold value t⁵ can be computed using equation (7), as follows:

t⁵=argmin_{t>0}SURE(t;y) (7),

with SURE

$$( t ; y ) = d - 2 \# \{ i : \vert {y}_{i} \vert \leq t \} + {\sum }_{i = 1}^{d} {min ( \vert {y}_{i} \vert , t )}^{2} ,$$

and y being a vector (y₁, y₂, . . . , y_{N}) that contains the wavelet coefficients (yⱼ=Dⱼ) at different decomposition levels. In this case, d is the length of (i.e., the number of components in) vector y, and # {i: |yᵢ|≦t} represents the total number of elements which are less than t.

In embodiments that operate to acquire raw electromagnetic measurement data 120 from resistivity logging tools, the data 120 may be available at different vertical resolutions (e.g., multiple arrays having various resolutions are commonly used in induction logging operations). In this case, the same noise source can be responsible for different amounts of noise corresponding to the different resolutions.

To improve results, threshold values for logs at different resolutions can be computed by performing a sequence of moving-window based data analyses along the entire depth of the log. Pre-determined and spatially-adaptive threshold values can be used as global thresholding values in conjunction with sub-band adaptive threshold values calculated for each decomposition level, as shown in equation (7), to improve the efficiency of thresholding 114 operations. Spatially-adaptive thresholding thus allows the use of different threshold values for log data collected at different resolutions, using different arrays.

### Signal Reconstruction 116 Activity

Finally, the transformed signal 130, 140 is synthesized using the altered approximation coefficients Â_{N} and detail coefficients \hat{D}ⱼ over the reconstruction levels 1 to N. A reconstruction high-pass filter RHP and reconstruction low-pass filter RLP are applied with an inverse wavelet transform as a part of signal reconstruction 116. In this case, the reconstruction high-pass filter RHP and reconstruction low-pass filter RLP are identical to the decomposition high-pass filter HP and decomposition low-pass filter LP, respectively, except with respect to the reverse time course. Thus, the following equations (8) can be applied to reconstruct the signal (as either one of the transformed signal 130 or 140):

$${\tilde{A}}_{n}^{j} = {\sum }_{k} {h}_{0 ( n - 2 k )} {\tilde{A}}_{k}^{j + 1} + {\sum }_{k} {h}_{1 ( n - 2 k )} {\tilde{D}}_{k}^{j + 1} , j \geq 1 , and \\ \tilde{x} = {\sum }_{k} {h}_{0 ( n - 2 k )} {\tilde{A}}_{k}^{1} + {\sum }_{k} {h}_{1 ( n - 2 k )} {\tilde{D}}_{k}^{1} . \qquad ( 8 )$$

Here, j≧1, and Â and \hat{D} represented the altered (thresholded) approximation and detail coefficients, respectively. The resulting clean data, with well-defined boundary layers, provides faster and more accurate inversion results.

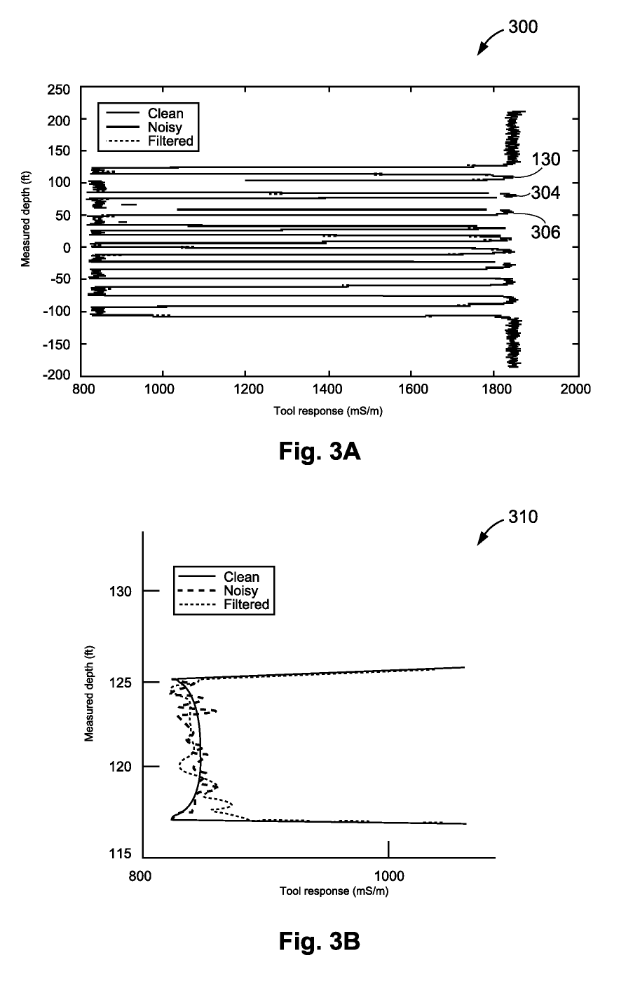

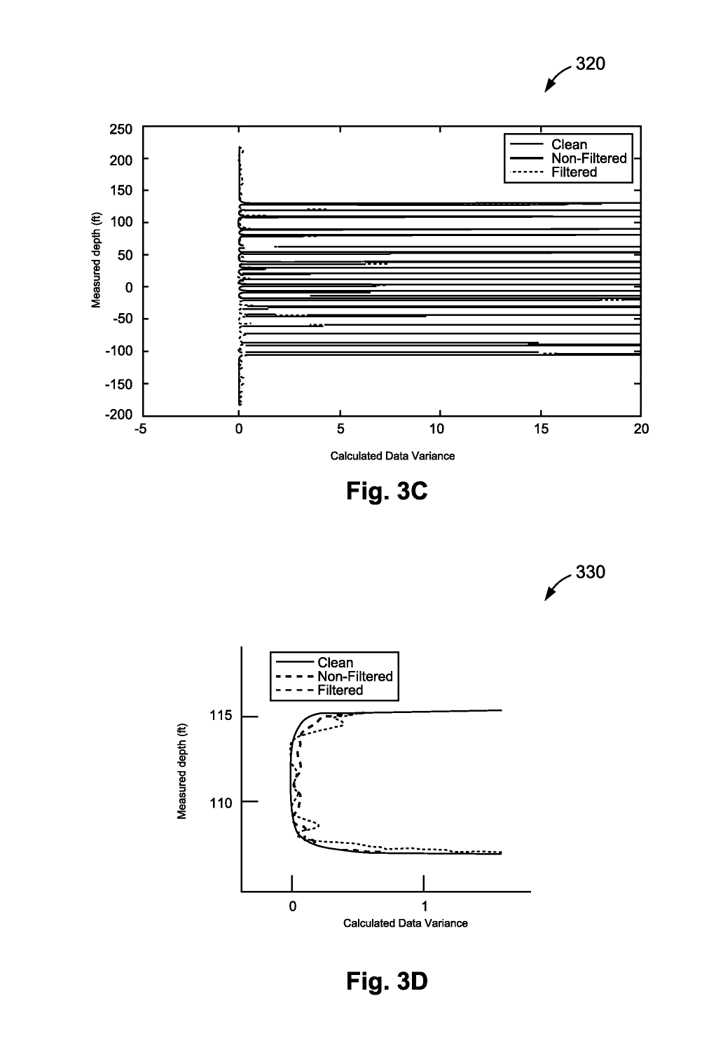

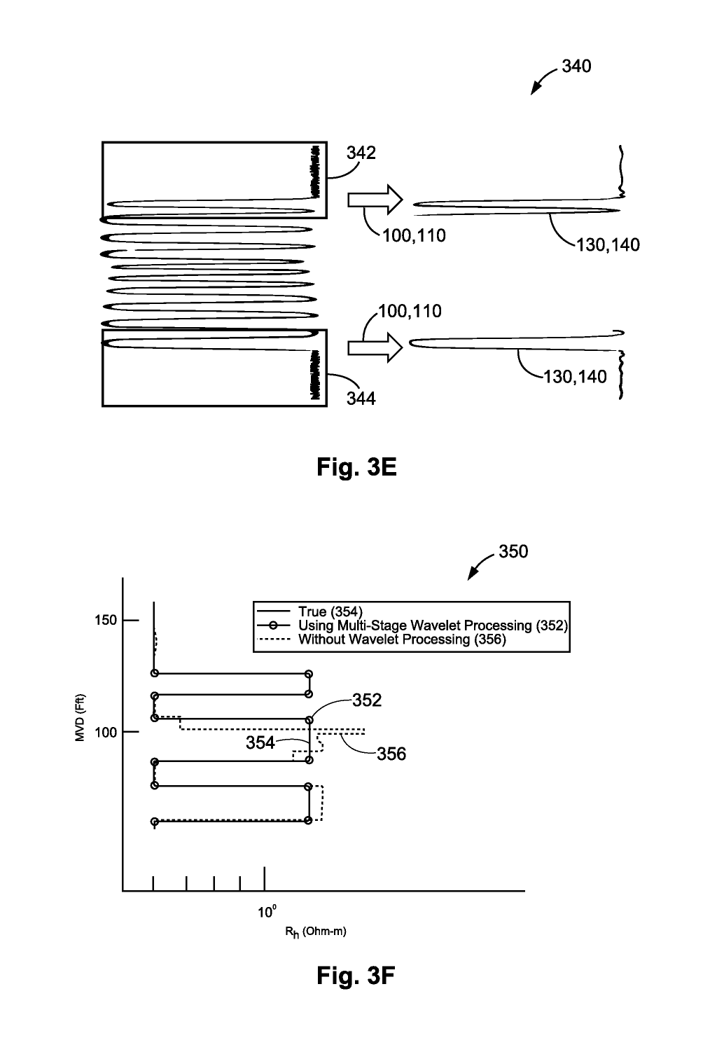

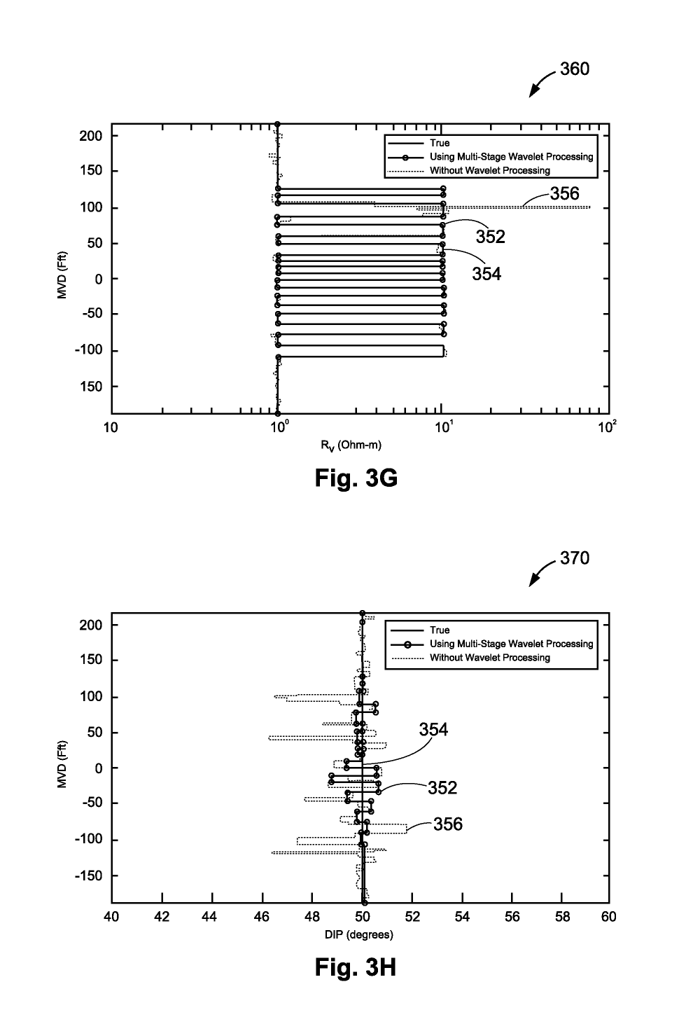

FIGS. 3A-3H are graphs 300-370 illustrating signal conditions at various stages in the measurement transformation processes and methods of FIGS. 1-2, according to various embodiments of the invention. In the following discussion, a synthetic inversion example for a multi-layer anisotropic formation is provided to demonstrate the efficiency of the proposed mechanism. Reference to the various activities in FIG. 2 may be useful as the discussion unfolds.

To begin, one may assume raw electromagnetic measurement data was acquired using an MCI tool with a transmitter-receiver spacing of about 0.5 m, and a working frequency of 20 KHz. The tool is assumed to be one that is employed as a resistivity logging tool to estimate formation parameters, and random white noise with an electrical conductivity of 10 mS/m was added into the synthetic conductivity data to provide a substantial noise level as part of the acquired conductivity information.

As part of the inversion processing, unknown formation properties including horizontal resistivity, vertical resistivity, and dipping angle were iteratively updated and optimized to reduce a misfit function defined between input synthetic measurement data and simulated data using forward modeling. In this example, the Gauss-Newton iterative method was employed as the update engine for the inversion/optimization activity.

In FIG. 3A, the original synthetic electromagnetic measurement data 302 (without noise), data with noise added 304, and filtered data 306, are shown as part of the graph 300. In this case, wavelet de-noising is applied to filter and smooth acquired data 304 over the entire log. In FIG. 3B, the graph 310 illustrates a magnified portion of the graph 300. This result might occur as part of the activity at block 225 in FIG. 2, for example.

Prior to performing a one-dimensional layered inversion, formation boundaries are determined. The variance in the filtered log data is used to detect formation bed boundaries according to equation (9), as follows:

$${F}_{j} = \frac{{\sum }_{i = - n}^{n} ( {X}_{j + i} - \frac{1}{2 n + 1} {\sum }_{i = - n}^{n} {X}_{j + i} )}{2 n + 1} \qquad ( 9 )$$

In equation (9), F is the variance calculated at each logging point j, X represents the log response, and n is the length of the selected variance window. Layer boundary positions are located around the peaks of the variance curve. Thus, the peak locations can be used to indicate initial boundary positions. For example, all logging points with a peak value of the variance curve larger than a predefined threshold value can be selected as starting point to locate bed boundaries.

After the data variance is initially calculated (see block 229 in FIG. 2), another wavelet smoothing process is employed (see block 233 in FIG. 2) to improve the quality of the computed data variance. Calculated data variance curves are illustrated in the graph 320 of FIG. 3C. A magnified section of the graph 320 is shown as graph 330 in FIG. 3D, where it can be seen that the filtered variance curve is smoother than the non-filtered variance curve. Indeed, as shown in FIGS. 3F-3G, use of the non-filtered variance curve may introduce false layer boundaries (which are absent when the filtered variance curve is used).

Based on the determined bed boundary locations, the whole log region is then divided into several sub-regions, which are solved successively (see block 237 in FIG. 2). As shown in FIG. 3E, for each sub-region 342, 344, a wavelet de-noising process 100, 110 is again applied to log data within that sub-region. Using filtered data, an iterative update method can be employed to solve for the formation properties associated with the data from each sub-region 342, 344.

After solving the individual inversion problem with respect to the data for each sub-region 342, 344, final inversion results can be obtained. Formation property values and one-dimensional layered inversion results, with and without wavelet processing are compared in FIGS. 3F-3H.

As seen in the figures, the transformed inversion results 352 provided after using the multi-stage wavelet-processing approach described herein are closer to the true formation properties 354 than the non-transformed (raw data) inversion results 356. This is more noticeable with respect to the accuracy improvement for the inverted dipping angle shown in FIG. 3H, than for the horizontal resistivity (FIG. 3F) and vertical resistivity (FIG. 3G), since the dipping angle DIP is generally more sensitive to noise than the horizontal and vertical resistivity Rh and Rv. For this reason, multi-stage wavelet processing can help reduce the possibility of delineating formation bed boundaries incorrectly in many embodiments.

As those of ordinary skill in the art will realize, after reading this document and studying the appended figures, the operations described herein can be utilized in a variety of apparatus and systems. Examples of such embodiments will now be described.

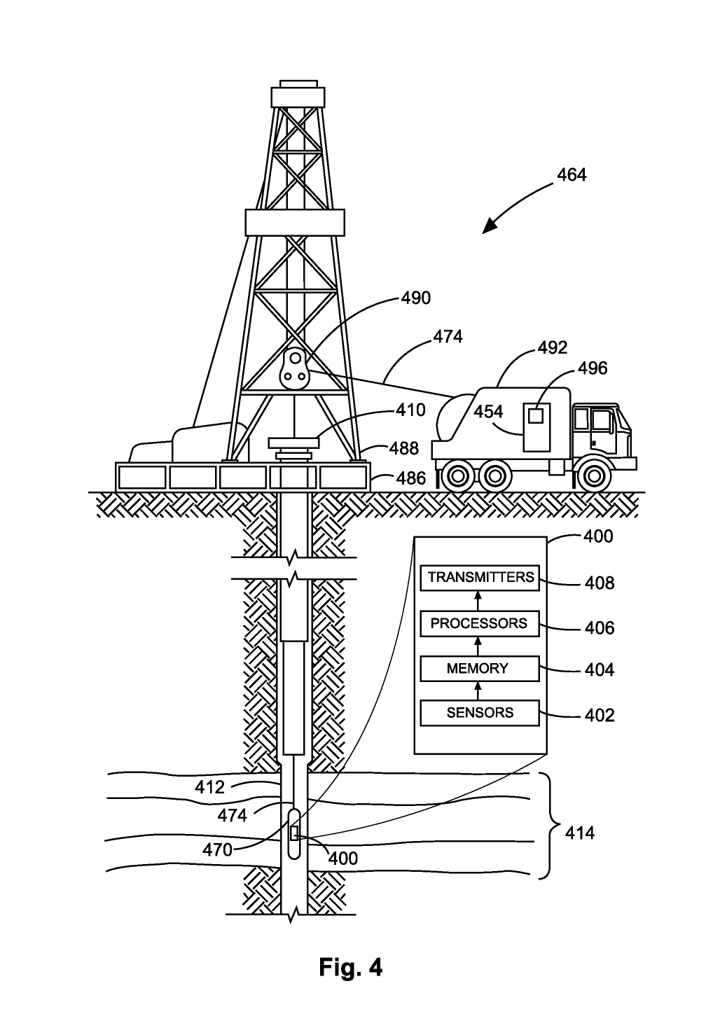

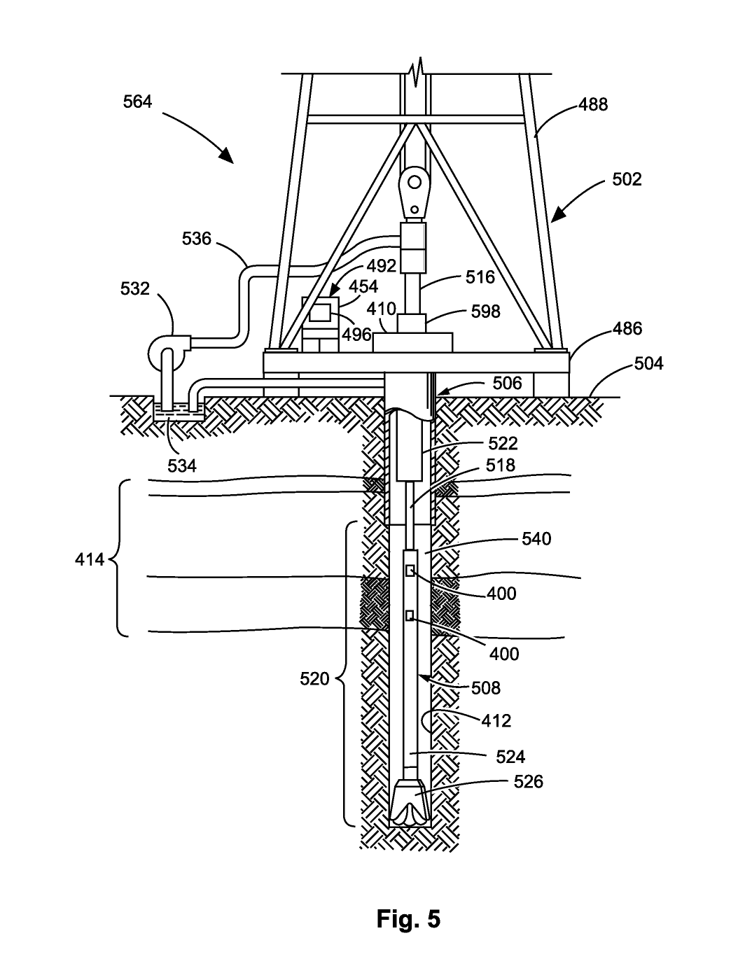

FIG. 4 illustrates a wireline system 464 embodiment of the invention, and FIG. 5 illustrates a drilling rig system 564 embodiment of the invention. Therefore, the systems 464, 564 may comprise portions of a wireline logging tool body 470 as part of a wireline logging operation, or of a down hole tool 524 as part of a down hole drilling operation.

Thus, FIG. 4 shows a well during wireline logging operations. In this case, a drilling platform 486 is equipped with a derrick 488 that supports a hoist 490.

Drilling oil and gas wells is commonly carried out using a string of drill pipes connected together so as to form a drilling string that is lowered through a rotary table 410 into a wellbore or borehole 412. Here it is assumed that the drilling string has been temporarily removed from the borehole 412 to allow a wireline logging tool body 470, such as a probe or sonde, to be lowered by wireline or logging cable 474 into the borehole 412. Typically, the wireline logging tool body 470 is lowered to the bottom of the region of interest and subsequently pulled upward at a substantially constant speed.

During the upward trip, at a series of depths various instruments (e.g., portions of the apparatus 400) included in the tool body 470 may be used to perform measurements on the subsurface geological formations 414 adjacent the borehole 412 (and the tool body 470). The measurement data can be communicated to a surface logging facility 492 for processing, analysis, and/or storage. The logging facility 492 may be provided with electronic equipment for various types of signal processing, which may also be implemented by any one or more of the components of the apparatus 400. Similarly, formation evaluation data may be gathered and processed during drilling operations (e.g., during logging while drilling (LWD) operations, and by extension, sampling while drilling).

In some embodiments, the tool body 470 is suspended in the wellbore by a wireline cable 474 that connects the tool to a surface control unit (e.g., comprising a workstation 454). The tool may be deployed in the borehole 412 on coiled tubing, jointed drill pipe, hard wired drill pipe, or any other suitable deployment technique.

The apparatus 400 may comprise a housing (e.g., the wireline tool body 470) to contain or attach to one or more sensors (e.g., receiver antennas forming part of an induction sensor) 402, memories 404, processors 406, telemetry transmitters 408, and other components. These components may cooperate to automatically implement any of the methods described herein.

Turning now to FIG. 5, it can be seen how a system 564 may also form a portion of a drilling rig 502 located at the surface 504 of a well 506. The drilling rig 502 may provide support for a drill string 508. The drill string 508 may operate to penetrate the rotary table 410 for drilling the borehole 412 through the subsurface formations 414. The drill string 508 may include a Kelly 516, drill pipe 518, and a bottom hole assembly 520, perhaps located at the lower portion of the drill pipe 518.

The bottom hole assembly 520 may include drill collars 522, a down hole tool 524, and a drill bit 526. The drill bit 526 may operate to create the borehole 412 by penetrating the surface 504 and the subsurface formations 414. The down hole tool 524 may comprise any of a number of different types of tools including measurement while drilling (MWD) tools, LWD tools, and others.

During drilling operations, the drill string 508 (perhaps including the Kelly 516, the drill pipe 518, and the bottom hole assembly 520) may be rotated by the rotary table 410. Although not shown, in addition to, or alternatively, the bottom hole assembly 520 may also be rotated by a motor (e.g., a mud motor) that is located down hole. The drill collars 522 may be used to add weight to the drill bit 526. The drill collars 522 may also operate to stiffen the bottom hole assembly 520, allowing the bottom hole assembly 520 to transfer the added weight to the drill bit 526, and in turn, to assist the drill bit 526 in penetrating the surface 504 and subsurface formations 414.

During drilling operations, a mud pump 532 may pump drilling fluid (sometimes known by those of ordinary skill in the art as “drilling mud”) from a mud pit 534 through a hose 536 into the drill pipe 518 and down to the drill bit 526. The drilling fluid can flow out from the drill bit 526 and be returned to the surface 504 through an annular area 540 between the drill pipe 518 and the sides of the borehole 412. The drilling fluid may then be returned to the mud pit 534, where such fluid is filtered. In some embodiments, the drilling fluid can be used to cool the drill bit 526, as well as to provide lubrication for the drill bit 526 during drilling operations. Additionally, the drilling fluid may be used to remove subsurface formation cuttings created by operating the drill bit 526. The system 564 may comprise one or more apparatus 400.

Thus, referring now to FIGS. 4-5, it may be seen that in some embodiments, the systems 464, 564 may include a drill collar 522, a down hole tool 524, and/or a wireline logging tool body 470 to house one or more apparatus 400.

Thus, for the purposes of this document, the term “housing” may include any one or more of a drill collar 522, a down hole tool 524, or a wireline logging tool body 470 (all having an outer surface and an inner surface, either of which can be attached to magnetometers, fluid sampling devices, pressure measurement devices, temperature measurement devices, other sensors, transmitters, receivers, acquisition and processing logic, and data acquisition systems). The tool 524 may comprise a down hole tool, such as an LWD tool or MWD tool. The wireline tool body 470 may comprise a wireline logging tool, including a probe or sonde, for example, coupled to a logging cable 474. Many embodiments may thus be realized.

For example, in some embodiments, a system 464, 564 may comprise a housing 470, 522, 524, one or more sensors that are used to acquire measurement data use to characterize a geological formation, and a processor to process the data to provide transformed measurement data.

Thus, a system 464, 564 may comprise a housing 470, 522, 524, at least one down hole sensor 402 attached to the housing 470, 522, 524, wherein the at least one down hole sensor 402 is configured to provide electromagnetic measurement data to characterize a geological formation 414. The system 464, 564 may further comprise one or more processors 406 to receive and transform the electromagnetic measurement data into transformed measurement data, as shown in FIGS. 1 and 2. That is, the processor(s) 406 may operate to compute a wavelet transform over the electromagnetic measurement data to provide wavelet coefficients, to remove the wavelet coefficients below a selected threshold to provide remaining coefficients, and to synthesize the transformed measurement data by computing a reverse wavelet transform over a combination of the remaining coefficients.

The processor(s) 406 can be used to decompose the wavelet coefficients. Thus, the wavelet coefficients may comprise approximation and detail coefficients, and the processor(s) 406 may be configured to decompose the approximation and the detail coefficients into additional approximation and detail coefficients, as described previously. The acquired measurement data, the decomposed wavelet coefficients, and the transformed measurement data may all be stored down hole in a memory 404, or on the surface 504 in a logging facility 492 (e.g., in a workstation 454), or both.

In some embodiments, the processor(s) 406 are located down hole. In some embodiments, processors 406 are located on the surface 504, perhaps as part of a workstation 454. In some embodiments, the processors 406 are located in both locations. Thus, the processor(s) 406 may be contained within the housing 470, 522, 524.

In some embodiments, an induction logging tool is used to acquire the data. Thus, the down hole sensors 402 may comprise an MCI induction logging tool.

In some embodiments, a transmitter is used to send acquired data to the surface for processing. Thus, a system 464, 564 may comprise a transmitter 408, in the form of a telemetry transmitter, to communicate the electromagnetic measurement data from the housing 470, 522, 524 to a surface workstation 454.

In some embodiments, a system 464, 564 may include a display 496 to publish acquired electromagnetic measurement data, decomposed coefficients, and transformed measurement data, among other information, perhaps in graphic form.

The apparatus 400; sensors 402; memory 404; processors 406; transmitters 408; rotary table 410; borehole 412; computer workstation 454; wireline logging tool body 470; logging cable 474; drilling platform 486; derrick 488; hoist 490; logging facility 492; display 496; drill string 508; Kelly 516; drill pipe 518; bottom hole assembly 520; drill collars 522; down hole tool 524; drill bit 526; mud pump 532; mud pit 534; and hose 536 may all be characterized as “modules” herein.

Such modules may include hardware circuitry, and/or a processor and/or memory circuits, software program modules and objects, and/or firmware, and combinations thereof, as desired by the architect of the apparatus 400 and systems 464, 564 and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, a data acquisition simulation package, and/or a combination of software and hardware used to simulate the operation of various potential embodiments.

It should also be understood that the apparatus and systems of various embodiments can be used in applications other than for logging operations, and thus, various embodiments are not to be so limited. The illustrations of apparatus 400 and systems 464, 564 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules. Such apparatus and systems may further be included as sub-components within a variety of electronic systems, such as televisions, cellular telephones, personal computers, workstations, radios, video players, vehicles, signal processing for geothermal tools and smart transducer interface node telemetry systems, among others. Some embodiments include a number of methods.

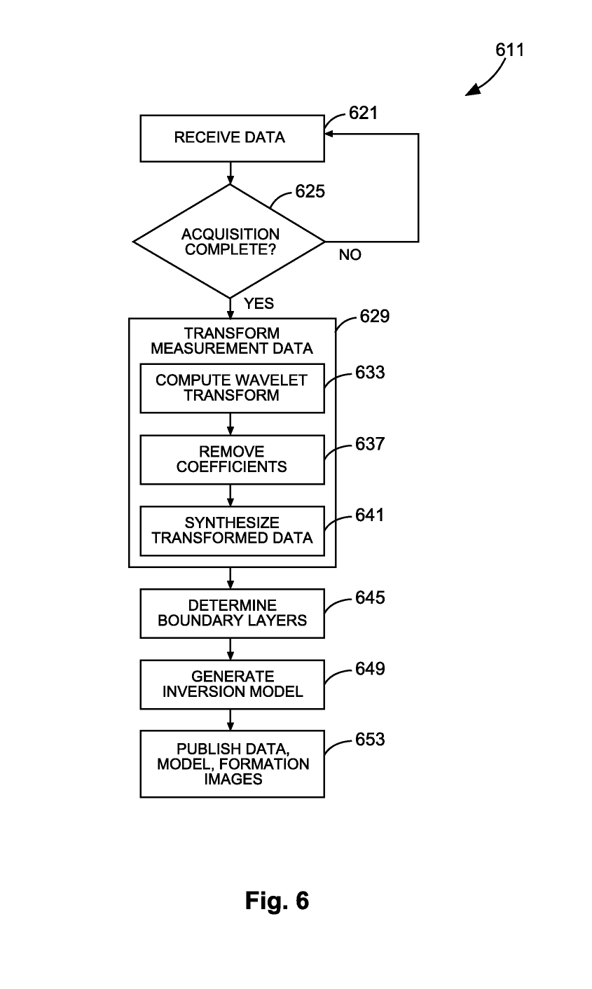

For example, FIG. 6 is a flow chart illustrating several additional methods 611 according to various embodiments of the invention. In some embodiments, a method 611 may comprise receiving electromagnetic measurement data at block 621, and transforming the data at block 629, using wavelet transformation, thresholding, and reverse wavelet transformation. The electromagnetic measurement data might be acquired for reception using induction or nuclear magnetic resonance tools.

Thus, a processor-implemented measurement transformation method 611, to execute on one or more processors that perform the method 611, may begin at block 621 with receiving electromagnetic measurement data characterizing a formation from at least one transmitter-receiver pair.

If the acquisition and reception of measurement data is complete, as determined at block 625, then the method 611 may continue on to block 629. Otherwise, the method 611 may return to block 621 to receive additional data.

Thus, the method 611 may include, at block 629, transforming the electromagnetic measurement data into transformed measurement data at block 629. The activity at block 629 may include computing a wavelet transform over the electromagnetic measurement data to provide wavelet coefficients at block 633, removing the wavelet coefficients below a selected threshold to provide remaining coefficients at block 637, and synthesizing the transformed measurement data by computing a reverse wavelet transform over a combination of the remaining coefficients at block 641.

Various activities in the method 611 can be interspersed with adaptive smoothing of the acquired data, as note previously. For example, the activities of computing, removing, and synthesizing at blocks 633, 637, and 641, respectively, may be performed as: (a) a first sequence of operations on the electromagnetic measurement data to provide de-noised raw data, (b) as a second sequence of operations on data variances in the de-noised raw data, and/or (c) after decomposing domains over a selected logging region, as a third sequence of operations on the electromagnetic measurement data in each of the domains to provide de-noised domain data as the transformed measurement data. Other sequences are also possible.

Wavelet computation may involve the computation of both wavelet functions and scaling functions. Thus, the activity of computing a wavelet transform at block 633 may comprise computing a wavelet function and a scaling function orthogonal to the wavelet function.

In some embodiments, only approximation coefficients are decomposed. Thus, the wavelet coefficients may comprise approximation coefficients, and computing the wavelet transform at block 633 may comprise decomposing the approximation coefficients at multiple levels.

In some embodiments, the wavelet transform can be computed as a wavelet-packet transform. Thus, the activity at block 633 may comprise transforming the electromagnetic measurement data into the transformed measurement data by computing the wavelet transform as a wavelet-packet transform over the electromagnetic measurement data to provide the wavelet coefficients.

Thresholding can be used to provide a reduced set of wavelet coefficients. Thus, the activity at block 637 may comprise removing the wavelet coefficients below the selected threshold to provide remaining coefficients, where the selected threshold comprises an adaptable threshold.

The threshold may be based on minimizing risk. Thus, the adaptable threshold may be selected based on minimizing Stein's Unbiased Estimate of Risk (SURE) or a Bayesian Estimate of Risk (BER), among others.

The threshold may be selected to remove frequencies below instrument resolution capability. Thus, the adaptable threshold may be selected to remove frequency components corresponding to frequencies below a resolution capability of a logging tool instrument, which may be determined by sensor spacing, such as antenna spacing—perhaps the physical distance between a transmitter and a receiver on a logging tool.

Moving window data analyses can be used to select the threshold. Thus, the adaptable threshold may be selected by performing a sequence of moving window data analyses.

Sub-band thresholding, obtained from decomposition levels, can be used to augment the moving window data analyses. Thus, the adaptable threshold selected by the moving window data analyses may be augmented by sub-band adaptive thresholding values calculated at a plurality of decomposition levels.

The wavelet coefficients remaining after some have been removed via thresholding may comprise a reduced set of approximation and detail coefficients. Thus, the remaining coefficients may comprise altered approximation and detail coefficients.

It is easier to find boundary layers in a formation when the acquired data has been de-noised by the transformation operation of block 629. Thus, once the boundary layers are located using the transformed measurement data, inversion can also be used to create a more accurate formation model.

Thus, the method 611 may continue on to block 645 to include determining boundary layers in the formation, based on the transformed measurement data. The method 611 may also continue on to block 649 to include generating an inversion model of the formation from the boundary layers and the transformed measurement data.

In some embodiments, a variety of information can be published to a display, a memory, or a hard copy printout. Thus, the method 611 may include, at block 653, publishing any one or more of the electromagnetic measurement data, the selected thresholds, the coefficients before and after thresholding, the transformed measurement data, the boundary layers, and images of the formation (based on the formation model), perhaps in graphic form.

It should be noted that the methods described herein do not have to be executed in the order described, or in any particular order. Moreover, various activities described with respect to the methods identified herein can be executed in iterative, serial, or parallel fashion. The various elements of each method (e.g., the methods shown in FIGS. 2 and 6) can be substituted, one for another, within and between methods. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. For example, the programs may be structured in an object-orientated format using an object-oriented language such as Java or C#. In another example, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

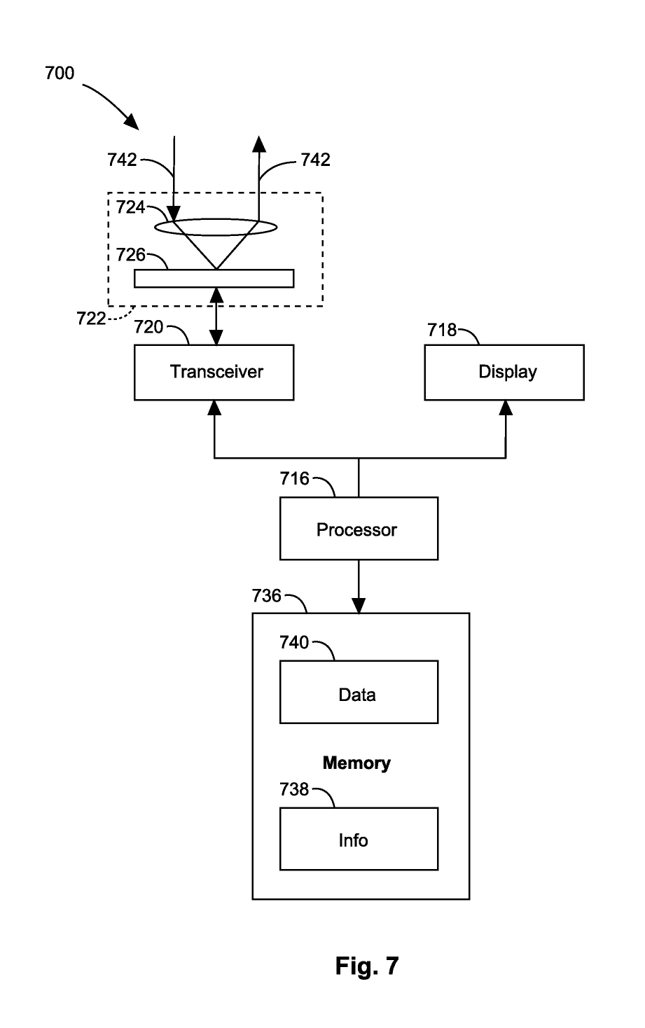

For example, FIG. 7 is a block diagram of an article 700 of manufacture according to various embodiments, such as a computer, a memory system, a magnetic or optical disk, or some other storage device. The article 700 may include one or more processors 716 coupled to a machine-accessible medium such as a memory 736 (e.g., removable storage media, as well as any tangible, non-transitory memory including an electrical, optical, or electromagnetic conductor) having associated information 738 (e.g., computer program instructions and/or data), which when executed by one or more of the processors 716, results in a machine (e.g., the article 700) performing any actions described with respect to the methods of FIGS. 2 and 6, and the apparatus and systems of FIGS. 4 and 5. The processors 716 may comprise one or more processors sold by Intel Corporation (e.g., Intel® Core™ processor family), Advanced Micro Devices (e.g., AMD Athlon™ processors), and other semiconductor manufacturers.

In some embodiments, the article 700 may comprise one or more processors 716 coupled to a display 718 to display data processed by the processor 716 and/or a wireless transceiver 720 (e.g., a down hole telemetry transceiver) to receive and transmit data processed by the processor.

The memory system(s) included in the article 700 may include memory 736 comprising volatile memory (e.g., dynamic random access memory) and/or non-volatile memory. The memory 736 may be used to store data 740 processed by the processor 716.

In various embodiments, the article 700 may comprise communication apparatus 722, which may in turn include amplifiers 726 (e.g., preamplifiers or power amplifiers) and one or more antenna 724 (e.g., transmitting antennas and/or receiving antennas). Signals 742 received or transmitted by the communication apparatus 722 may be processed according to the methods described herein.

Many variations of the article 700 are possible. For example, in various embodiments, the article 700 may comprise a down hole tool, including the apparatus 400 shown in FIGS. 4 and 5. In some embodiments, the article 700 is similar to or identical to the system 464, 565 shown in FIGS. 4 and 5, respectively.

In summary, the apparatus, systems, and methods disclosed herein may provide electromagnetic data with a reduced level of noise, leading to better-defined boundary layers, with faster and more accurate inversion results. As an example, transformed logging data originally provided by resistivity induction logging tools can be used in numerical optimization operations to provide more accurate evaluations of formation properties. The efficiency and accuracy provided by this activity can significantly enhance the value of services provided by an operation/exploration company.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system, comprising:
a housing;
at least one down hole sensor attached to the housing, the at least one down hole sensor to provide electromagnetic measurement data to characterize a geological formation; and
a processor to receive and transform the electromagnetic measurement data into transformed measurement data by computing a wavelet transform over the electromagnetic measurement data to provide wavelet coefficients, to remove the wavelet coefficients below a selected threshold to provide remaining coefficients, and to synthesize the transformed measurement data by computing a reverse wavelet transform over a combination of the remaining coefficients.

2. The system of claim 1, wherein the processor is contained within the housing.

3. The system of claim 1, wherein the at least one down hole sensor comprises a multi-component induction (MCI) logging tool.

4. The system of claim 1, further comprising:
a telemetry transmitter to communicate the electromagnetic measurement data from the housing to a surface workstation.

5. The system of claim 1, wherein the housing comprises one of a wireline tool or a measurement while drilling tool.

6. The system of claim 1, wherein the wavelet coefficients comprise approximation and detail coefficients, and wherein the processor is configured to decompose the approximation and the detail coefficients into additional approximation and detail coefficients.

7. A processor-implemented temperature compensation method, to execute on one or more processors that perform the method, comprising:
receiving electromagnetic measurement data characterizing a formation from at least one transmitter-receiver pair; and
transforming the electromagnetic measurement data into transformed measurement data by computing a wavelet transform over the electromagnetic measurement data to provide wavelet coefficients, removing the wavelet coefficients below a selected threshold to provide remaining coefficients, and synthesizing the transformed measurement data by computing a reverse wavelet transform over a combination of the remaining coefficients.

8. The method of claim 7, wherein computing a wavelet transform comprises:
computing a wavelet function and a scaling function orthogonal to the wavelet function.

9. The method of claim 7, wherein the wavelet coefficients comprise approximation coefficients, and wherein computing the wavelet transform comprises:
decomposing the approximation coefficients at multiple levels.

10. The method of claim 7, wherein the removing further comprises:
removing the wavelet coefficients below the selected threshold to provide remaining coefficients, the selected threshold comprising an adaptable threshold.

11. The method of claim 10, wherein the remaining coefficients comprise altered approximation and detail coefficients.

12. The method of claim 10, wherein the adaptable threshold is selected based on minimizing Stein's Unbiased Estimate of Risk (SURE) or a Bayesian Estimate of Risk (BER).

13. The method of claim 10, wherein the adaptable threshold is selected to remove frequency components corresponding to frequencies below a resolution capability of a logging tool instrument.

14. The method of claim 13, wherein the resolution capability of the logging tool instrument is determined by a physical distance between a transmitter and a receiver.

15. The method of claim 10, wherein the adaptable threshold is selected by performing a sequence of moving window data analyses.

16. The method of claim 15, wherein the adaptable threshold selected by the moving window data analyses is augmented by sub-band adaptive thresholding values calculated at a plurality of decomposition levels.

17. The method of claim 7, wherein the computing, the removing, and the synthesizing are performed:
as a first sequence of operations on the electromagnetic measurement data to provide de-noised raw data;
as a second sequence of operations on data variances in the de-noised raw data; and
after decomposing domains over a selected logging region, as a third sequence of operations on the electromagnetic measurement data in each of the domains to provide de-noised domain data as the transformed measurement data.

18. An article including a machine-accessible medium having instructions stored therein, wherein the instructions, when accessed, result in a machine performing:
receiving electromagnetic measurement data characterizing a formation from at least one transmitter-receiver pair; and
transforming the electromagnetic measurement data into transformed measurement data by computing a wavelet transform over the electromagnetic measurement data to provide wavelet coefficients, removing the wavelet coefficients below a selected threshold to provide remaining coefficients, and synthesizing the transformed measurement data by computing a reverse wavelet transform over a combination of the remaining coefficients.

19. The article of claim 18, wherein the instructions, when accessed, result in the machine performing:
transforming the electromagnetic measurement data into the transformed measurement data by computing the wavelet transform as a wavelet-packet transform over the electromagnetic measurement data to provide the wavelet coefficients.

20. The article of claim 18, wherein the instructions, when accessed, result in the machine performing:
determining boundary layers in the formation, based on the transformed measurement data; and
generating an inversion model of the formation from the boundary layers and the transformed measurement data.
